(19) United States
(12) Patent Application Publication
(10) Pub. No.: US 2024/0351873 A1
(43) Pub. Date: Oct. 24, 2024

(54) HYDROGEN PRODUCTION SYSTEM

(71) Applicants: HYUNDAI MOTOR COMPANY, Seoul (KR); KIA CORPORATION, Seoul (KR); RESEARCH & BUSINESS FOUNDATION SUNGKYUNKWAN UNIVERSITY, Suwon-si (KR)

(72) Inventors: Haeun Jeong, Uiwang-si (KR); Young Gul Hur, Uiwang-si (KR); Pyung Soon Kim, Suwon-si (KR); Kyung Soo Park, Seoul (KR); Jiyong Kim, Suwon-si (KR)

(73) Assignees: HYUNDAI MOTOR COMPANY, Seoul (KR); KIA CORPORATION, Seoul (KR); RESEARCH & BUSINESS FOUNDATION SUNGKYUNKWAN UNIVERSITY, Suwon-si (KR)

(21) Appl. No.: 18/523,557

(22) Filed: Nov. 29, 2023

(30) Foreign Application Priority Data
Apr. 20, 2023 (KR) 10-2023-0051771

(51) Int. Cl. C01B 3/38; B01D 53/00; B01D 53/047; C01B 3/50; C01B 3/56; C01B 32/40

(52) U.S. Cl. CPC C01B 3/38; B01D 53/002; B01D 53/047; C01B 3/506; C01B 3/56; C01B 32/40; B01D 2256/22; B01D 2256/245; B01D 2257/108; B01D 2257/502; C01B 2203/0238; C01B 2203/0425; C01B 2203/046; C01B 2203/065; C01B 2203/0811; C01B 2203/1241; C01B 2203/1258

(57) ABSTRACT

A hydrogen production system includes a desulfurization unit configured to remove a sulfur component from hydrocarbon gas. The system has a pre-reforming unit configured to convert hydrocarbons having two or more carbon atoms into methane (CH₄) by reacting the hydrocarbon gas with water (H₂O) vapor. The system has a mixed reforming unit configured to produce hydrogen (H₂) and carbon monoxide (CO) by performing a mixed reforming reaction between the reaction product of the pre-reforming unit and carbon dioxide (CO₂). The system has a separation unit for separating hydrogen (H₂) and CO from the reaction product of the mixed reforming unit. The system has a first heat exchange unit configured to generate water vapor supplied to the pre-reforming unit using the heat of the reaction product of the mixed reforming unit.

### CROSS-REFERENCE TO RELATED APPLICATION

This application claims priority to and the benefit of Korean Patent Application No. 10-2023-0051771 filed in the Korean Intellectual Property Office on Apr. 20, 2023, the entire contents of which are incorporated herein by reference.

### BACKGROUND

### (a) Field of the Disclosure

This disclosure relates to a hydrogen production system using a mixed reforming method.

### (b) Description of the Related Art

Recently, global movements for preventing climate change have become more active. Hydrogen is very valuable as a clean energy source or an energy storage means.

However, hydrogen may not be said to be environmentally friendly, when considering current hydrogen production methods. Approximately 96% of hydrogen worldwide is produced through a catalytic chemical reaction of methane, a main component of natural gas, with high-temperature water vapor. During production, about 1 kg of hydrogen is produced, while about 10 kg or more of carbon dioxide is discharged. Carbon dioxide is a main component of greenhouse gases and causes global warming.

Attempts to capture and store the carbon dioxide (CCS) without releasing it into the atmosphere are being made. However, such attempts may be possible only in places with appropriate geological structures such as aquifers and coal seams and in oil/gas fields capable of enhanced oil recovery (EOR).

Even when renewable energy with the lowest carbon dioxide discharge is used, hydrogen production is possible only in areas with suitable weather and climate. However, since the weather is difficult to predict, there is a drawback in that it is impossible to produce stable electric power by using the renewable energy.

### SUMMARY

In a hydrogen production system according to one aspect of the present disclosure, when producing hydrogen by reforming methane (CH₄), a mixed reforming method using carbon dioxide (CO₂) as a reactant is used. Unreacted carbon dioxide is recycled to increase overall carbon efficiency and a carbon dioxide discharge amount may be reduced throughout the process.

A hydrogen production system according to one aspect of the present disclosure includes a desulfurization unit configured to remove a sulfur component from hydrocarbon gas. The system also has a pre-reforming unit configured to convert hydrocarbons having two or more carbon atoms into methane (CH₄) by reacting the hydrocarbon gas with water (H₂O) vapor. The system also has a mixed reforming unit configured to produce hydrogen (H₂) and carbon monoxide (CO) by performing a mixed reforming reaction between the reaction product of the pre-reforming unit and carbon dioxide (CO₂). The system also has a separation unit for separating hydrogen (H₂) and carbon monoxide (CO) from the reaction product of the mixed reforming unit. The system also has a first heat exchange unit configured to generate water vapor supplied to the pre-reforming unit using the heat of the reaction product of the mixed reforming unit.

The hydrocarbon gas may include C₁ to C₂₀ alkane, C₁ to C₂₀ alkene, C₂ to C₂₀ alkyne, carbon dioxide, ammonia, formic acid (HCO₂H), methanol (CH₃OH), or a combination thereof.

The pre-reforming unit may react hydrocarbon gas with water vapor to convert hydrocarbons having two or more carbon atoms into methane (CH₄) and at the same time may remove remaining sulfur component.

The pre-reforming unit may be performed at a pressure of about 1 bar to about 30 bar and a temperature of about 300° C. to about 650° C.

The mixed reforming unit may be performed at a pressure of about 1 bar to about 30 bar and a temperature of about 700° C. to about 1000° C.

The hydrogen production system may further include a heat supply unit that combusts hydrocarbon gas to generate a combustion product.

The hydrogen production system may further include a second heat exchange unit that supplies heat to the reaction product of the pre-reforming unit and carbon dioxide using heat from the combustion product.

The unreacted gas separated in the separation unit may be supplied back to the mixed reforming unit through the second heat exchange unit.

The hydrogen production system may further include a third heat exchange unit that supplies heat to the hydrocarbon gas and water vapor using heat from combustion product.

The combustion product supplied to the third heat exchange unit may be supplied to the third heat exchange unit through the second heat exchange unit.

The carbon dioxide may be supplied from the front end, i.e., upstream end of the pre-reforming unit, pass through the third heat exchange unit, the pre-reforming unit, and the second heat exchange unit, and then be supplied to the mixed reforming unit.

The hydrogen production system may further include a carbon dioxide capture unit that captures carbon dioxide from combustion product that has passed through the third heat exchange unit and that supplies the captured carbon dioxide to the front or upstream end of the pre-reforming unit.

The carbon dioxide capture unit may capture carbon dioxide from the unreacted gas separated in the separation unit.

In the carbon dioxide capture unit, the carbon dioxide may be captured using an absorption method, an adsorption method, a separation membrane method, or a cryogenic separation method.

The separating via the separation unit may be performed using pressure swing adsorption, membrane separation, or cryogenic separation.

The separation unit may include a first separation device that separates carbon monoxide using a cryogenic separation method and may include a second separation device that is disposed at the rear or downstream end of the first separation device and separates hydrogen using a pressure swing adsorption method.

In one aspect of the present disclosure, the hydrogen production system uses a mixed reforming method that uses carbon dioxide (CO₂) as a reactant when producing hydrogen by reforming methane. The system recycles unreacted carbon dioxide to increase overall carbon efficiency and reduces a carbon dioxide discharge amount throughout the process.

### BRIEF DESCRIPTION OF THE DRAWINGS

FIG. 1 is a block flow diagram of a hydrogen production system according to one aspect of the present disclosure.

FIG. 2 is a block flow diagram of a modified example of a hydrogen production system according to one aspect of the present disclosure.

FIG. 3 is a block flow diagram of a modified example of a hydrogen production system according to one aspect of the present disclosure.

FIG. 4 is a diagram showing a device configuration of a hydrogen production system according to Example 1.

FIG. 5 is a diagram showing a device configuration of a hydrogen production system according to Example 2.

FIG. 6 is a diagram showing a device configuration of a hydrogen production system according to Comparative Example 1.

FIG. 7 is a graph showing energy efficiency calculation results of Example 1, Example 2, and Comparative Example 1.

### DETAILED DESCRIPTION OF THE EMBODIMENTS

The advantages, features, and aspects described below should become apparent from the following description of the embodiments with reference to the accompanying drawings. However, the present disclosure may be not limited to embodiments that are described herein. Unless otherwise defined, all terms (including technical and scientific terms) used in this specification may be used with meanings that can be commonly understood by those of ordinary skill in the art. The terms have specific meanings coinciding with related technical references and the present specification as well as lexical meanings. In other words, the terms are not to be construed as having idealized or formal meanings.

Throughout the following specification and claims, unless explicitly described to the contrary, the words “comprise/include” or variations such as “compises/includes” or “comprising/including” should be understood to imply the inclusion of stated elements but not the exclusion or any other elements.

Further, the singular includes the plural unless mentioned otherwise. Also, as used herein, the term “about”, when referring to ranges or to measured, detected, or determined values, means to include the stated value plus or minus normal error or normal deviation according to the equipment used. Also, the stated ranges herein are intended to include the range boundary values, any values between the stated range boundaries, and the normal error or normal deviation. Hence the term “about” may be utilized with such values and boundaries.

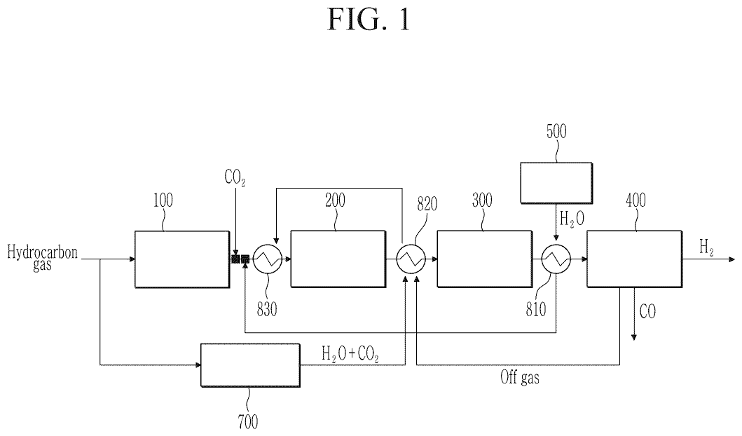

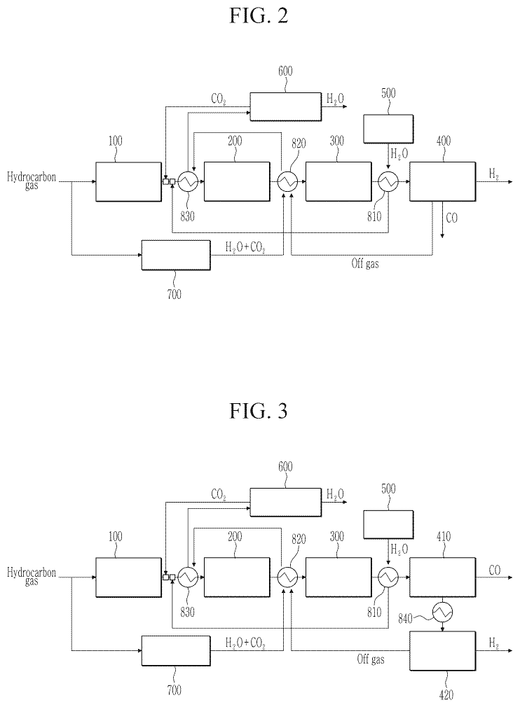

FIG. 1 is a block flow diagram of a hydrogen production system according to one aspect of the present disclosure. FIG. 2 is a block flow diagram of a modified example of a hydrogen production system according to one aspect of the present disclosure. FIG. 3 is a block flow diagram of a modified example of a hydrogen production system according to one aspect of the present disclosure. Hereinafter, a hydrogen production system is described in detail with reference to FIGS. 1-3.

The hydrogen production system includes a desulfurization unit 100, a preliminary reforming unit 200, a mixed reforming unit 300, and a separation unit 400.

In the desulfurization unit 100, sulfur components are removed from hydrocarbon gas.

Since the sulfur components included in the hydrocarbon gas can act as a catalyst poison that weakens activity of the catalyst used in the rear or downstream end pre-reforming unit 200 or mixed reforming unit 300, it needs to be removed in advance.

The hydrocarbon gas may include C₁ to C₂₀ alkane, C₁ to C₂₀ alkene, C₂ to C₂₀ alkyne, carbon dioxide (CO₂), ammonia, formic acid (HCO₂H), methanol (CH₃OH), or a combination thereof. For example, the hydrocarbon gas may include natural gas.

The desulfurization unit 100 may use, for example, adsorptive desulfurization or hydrodesulfurization.

As an example, the desulfurization unit 100 may be performed so that a content of the sulfur component in the hydrocarbon gas may be in a range of about 0.1 ppb to about 100 ppb.

In the pre-reforming unit 200, hydrocarbon gas and water (H₂O) vapor react to convert hydrocarbons having two or more carbon atoms into methane (CH₄).

The hydrocarbons having two or more carbon atoms may be, for example, higher hydrocarbons having two to four carbon atoms. The natural gas contains hydrocarbon gas (tailoring gas) with more than two carbon atoms in addition to methane, which is the main component. Since these hydrocarbon gases having two or more carbon atoms cause carbon deposition in the mixed reforming reaction, a pre-reforming process is required to convert them into methane before being supplied to the mixed reforming unit 300.

For example, in the pre-reforming unit 200, most hydrocarbons having two to four carbon atoms are converted to methane by reaction with water (H₂O) vapor in the presence of a metal catalyst.

The metal catalyst may include, for example, nickel, ruthenium, rhodium, palladium, iridium, platinum, or a combination thereof. In addition, when a high content of nickel is used as the metal catalyst, hydrocarbons having two or more carbon atoms may be converted into methane (CH₄), and the residual sulfur components may be removed at the same time.

The pre-reforming unit 200 may have a temperature range and a pressure range of, for example, about 300° C. to about 650° C. and about 1 bar to about 30 bar. When the reaction temperature of the pre-reforming unit 200 is less than about 300° C., a reaction speed and a methane conversion rate may be low. However, when the reaction temperature is greater than about 650° C., carbon deposition may be increased. In addition, when the pre-reforming unit 200 has a reaction pressure of less than about 1 bar, a conversion rate of methane may be lower, and carbon deposition may be increased. However, when the pre-reforming unit 200 has a reaction pressure of greater than about 30 bar, a device configuration cost may increase.

In the mixed reforming unit 300, hydrogen (H₂) and carbon monoxide (CO) are produced through a mixed reforming reaction of a reaction product of the pre-reforming unit 200 and carbon dioxide (CO₂).

The mixed reforming reaction may be performed by injecting a reaction gas containing hydrocarbon gas, water (H₂O) vapor, and carbon dioxide (CO₂) under a catalyst and then, performing a heat treatment.

For example, the reaction gas may include methane, carbon dioxide as an oxidizing agent, and water vapor, wherein a reaction product of the mixed reforming unit 300 may include hydrogen and carbon monoxide.

In the separation unit 400, hydrogen (H₂) and carbon monoxide (CO) are separated from the reaction product of the mixed reforming unit 300.

For example, in the separation unit 400, after separating water from the reaction product of the mixed reforming unit 300, the remaining gas (off-gas) containing carbon monoxide, carbon dioxide, hydrogen, methane, etc. may be recirculated and recycled to the mixed reforming unit 300.

When this off-gas is recycled, a recycling rate of the off-gas may be about 60 volume % to about 90 volume % based on a total volume of the off-gas. When the off-gas has a recycling rate of less than about 60 volume %, a conversion rate, thermal efficiency, and carbon efficiency of the reaction gas may be lowered. When the off-gas has a recycling rate of greater than about 90 volume %, the off-gas may be accumulated, reducing productivity.

For example, the separation unit 400 may be performed by using a pressure swing adsorption, membrane separation, or cryogenic separation method.

The separation unit 400 may determine a separation order of hydrogen and carbon monoxide by considering characteristics and energy efficiency of an adsorbent or a separation membrane. For example, the separation unit 400 may include a first separation device 410 separating the carbon monoxide in a cryogenic separation method. The separation unit 400 may also include a second separation device 420 disposed at the rear end, i.e., downstream end of the first separation device 410 and separating the hydrogen by using a pressure swing adsorption method. Herein, a fourth heat exchange unit 840 may be further included between the first separation device 410 and the second separation device 420.

The hydrogen production system may include a first heat exchange unit 810 generating water vapor supplied to the pre-reforming unit 200 by using heat of the reaction product of the mixed reforming unit 300. The first heat exchange unit 810 may be disposed at the rear end, i.e., downstream end of the mixed reforming unit 300.

The hydrogen production system may further include a water supply unit 500 supplying water (H₂O), wherein the water supply unit 500 may supply the water to the first heat exchange unit 810. The water supplied to the first heat exchange unit 810 may be converted into the water vapor by using the heat of the reaction product of the mixed reforming unit 300.

The water vapor produced in the first heat exchange unit 810 may be moved toward the front end, i.e., upstream end of the pre-reforming unit 200 and then supplied to the pre-reforming unit 200. However, the present aspect is not limited to the foregoing. The water supply unit 500 can directly supply water to the pre-reforming unit 200 and can also convert water into water vapor through a separate device. In addition, the water may be converted into the water vapor by a second heat exchange unit 820 or a third heat exchange unit 830, as described below.

Optionally, the hydrogen production system may further include a heat supply unit 700, which combusts hydrocarbon gas and generates a combustion product.

The heat supply unit 700 may be supplied with hydrocarbon gas from the front or upstream end of the desulfurization unit 100. Accordingly, the combustion product may include water vapor (H₂O) and carbon dioxide (CO₂) as a main component.

For example, the heat supply unit 700 may be configured as a burner or an electric furnace.

Optionally, the hydrogen production system may further include the second heat exchange unit 820, which supplies heat to the reaction product of the pre-reforming unit 200 and carbon dioxide by using the heat of the combustion product. The second heat exchange unit 820 may be disposed between the pre-reforming unit 200 and the mixed reforming unit 300.

For example, the front end, i.e., upstream end of the mixed reforming unit 300 requires the largest temperature increase in the hydrogen production system. Accordingly, the heat produced in the heat supply unit 700 may be supplied to the reaction product of the pre-reforming unit 200 and carbon dioxide in the second heat exchange unit 820 at the front or upstream end of the mixed reforming unit 300. However, the present aspect is not limited the foregoing. The heat produced in the heat supply unit 700 may be supplied to the first heat exchange unit 810 or the third heat exchange unit 830, as described below.

On the other hand, unreacted gas separated in the separation unit 400 may be supplied again to the mixed reforming unit 300 through the second heat exchange unit 820. In other words, the second heat exchange unit 820 may the heat of the combustion product to supply the heat to the recirculated unreacted gas.

Optionally, the hydrogen production system may further include the third heat exchange unit 830 using the heat of the combustion product to supply the heat to hydrocarbon gas and water vapor. The third heat exchange unit 830 may be disposed between the desulfurization unit 100 and the pre-reforming unit 200.

Herein, the combustion product, which is supplied to the third heat exchange unit 830, may be supplied through the second heat exchange unit 820 to the third heat exchange unit 830.

Optionally, the hydrogen production system may further include a carbon dioxide supply unit for supplying carbon dioxide. The carbon dioxide supply unit may supply the carbon dioxide from the front or upstream end of the pre-reforming unit 200, the front or upstream end of the mixed reforming unit 300, or a combination thereof.

For example, when the carbon dioxide is supplied from the front end, i.e., upstream end of the pre-reforming unit 200, the carbon dioxide may be supplied to the mixed reforming unit 300 through the third heat exchange unit 830, the pre-reforming unit 200, and the second heat exchange unit 820. In the pre-reforming unit 200, the carbon dioxide is not used due to temperature and catalyst conditions but is supplied to the mixed reforming unit 300 through the third heat exchange unit 830, the pre-reforming unit 200, and the second heat exchange unit 820. This improves thermal efficiency of the hydrogen production system.

Optionally, the hydrogen production system may further include a carbon dioxide capture unit 600. The carbon dioxide capture unit 600 may be disposed between the desulfurzation unit 100 and the pre-reforming unit 200.

For example, the carbon dioxide capture unit 600 may capture carbon dioxide from the combustion product passing through the third heat exchange unit 830 and then supply the captured carbon dioxide to the front or upstream end of the pre-reforming unit 200. In addition, the carbon dioxide capture unit 600 may capture carbon dioxide from the unreacted gas separated in the separation unit 400 and then supply the captured carbon dioxide to the front or upstream end of the pre-reforming unit 200.

In the carbon dioxide capture unit 600, carbon dioxide may be captured using an absorption method, an adsorption method, a separation membrane method, or a cryogenic separation method.

Hereinafter, referring to FIG. 1, a method of operating the hydrogen production system according to one aspect is described.

For example, a sulfur component included in natural gas is removed through the desulfurization unit 100. The residual sulfur component is removed through the pre-reforming unit 200 containing a high-content nickel catalyst. Hydrocarbons having two or more carbon atoms in the natural gas are converted to CH₄, which is supplied to the mixed reforming unit 300. Herein, water vapor is supplied to the pre-reforming unit 200 through the first heat exchange unit 810. The mixed reforming unit 300 has an endothermic reaction, which may be expressed by Reaction Scheme 1.

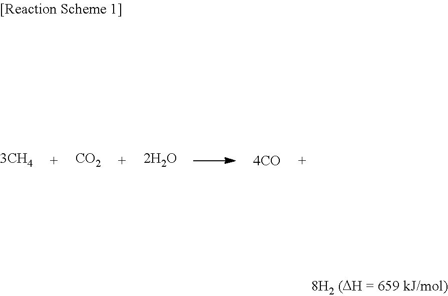

As shown in Reaction Scheme 1, CO₂ may be converted to produce CO, which is a reducing gas or a raw material of a high value-added compound. This results in reducing the CO₂ discharge amount of the entire process.

The second heat exchange unit 820 supplies heat energy required for the reaction into the mixed reforming unit 300.

The reaction product of the mixed reforming unit 300 includes oxygen and carbon monoxide and, in addition, some unreacted methane and a small amount of carbon dioxide. The reaction product of this mixed reforming unit 300 is separated respectively into hydrogen gas and carbon monoxide gas in the separation unit 400. The residual unreacted gas of the separation unit 400 is recirculated into the second heat exchange unit 820 to supply the heat energy.

For example, the separation unit 400 may perform cryogenic separation, (cold box) to separate CO in the first separation device 410. Since gas components after the mixed reforming reaction include CO₂, CH₄, CO, or H₂, etc. which all have different boiling points, CO may be separated therefrom according to the different boiling points. Herein, CH₄ flash gas may be recirculated and used as a heat source. After separating CO, in the second separation device 420, H₂ may be separated in a pressure swing adsorption method. Herein, the unreacted gas may be resupplied to the heat supply unit 700 and used as a heat source.

In the present example embodiment, carbon dioxide may be captured at the rear end, i.e., downstream end of the mixed reforming unit 300, the rear end of the separation unit 400, the rear end of the second heat exchange unit 820, or the rear end of the third heat exchange unit 830. When carbon dioxide is captured and recirculated, not only may a CO₂ discharge amount be reduced, but also overall carbon efficiency of the process may be increased.

In this way, the hydrogen production system according to this aspect may produce hydrogen and, simultaneously, convert carbon dioxide by mixing and reforming methane, water vapor, and carbon dioxide. The hydrogen production system may use CO₂ as a reactant and convert it, reducing discharged CO₂ by about 47% or more.

It is desirable to produce green hydrogen with the lowest CO₂ discharge amount. Though renewable energy should be stably supplied, general blue hydrogen production methods of steam reforming and CO₂ capture processes cannot store all captured CO₂ due to a limited CO₂ storage area but have to discharge CO₂ beyond the storage. In order to environmentally-friendly produce hydrogen under these limitations, the mixed reforming process according to the present disclosure may be an alternative.

In addition, a conventional mixed reforming reaction is used in a process of producing desired chemical raw materials such as methanol by adjusting a H₂/CO ratio within a range of about 1 to 3. When there is no economic burden on the CO₂ discharge, the steam reforming method may be advantageous for producing hydrogen. However, as a CO₂ discharge cost increases due to CO₂ taxes or carbon discharge rights, etc. in the future, the demand for a low-carbon hydrogen production system is expected to increase.

As of 2022, Europe's carbon tax ranges from $0.08 to $130, and Korea is implementing a carbon discharge trading system instead of the carbon tax. When considering that the carbon taxes or carbon discharge rights will be increased in the future as a response to climate change, the mixed reforming method may be more advantageous than the steam reforming process in terms of environmental as well as economical aspects.

The low carbon hydrogen production system according to one aspect of the present disclosure may reduce CO₂ without significantly changing the current hydrogen production infrastructure. In addition, unreacted CO₂ may be recycled to increase overall carbon efficiency and reduce a CO₂ discharge amount throughout the process. In addition, the hydrogen production system may lower a unit cost of producing hydrogen, even when a cost of generating CO from the mixed reforming is increased.

Hereinafter, specific examples of the present disclosure are presented. However, the examples described below are only for specifically illustrating or explaining the present disclosure. The scope of the disclosure is not limited thereto.

### EXAMPLE: SIMULATION OF HYDROGEN PRODUCTION SYSTEM

### Example 1

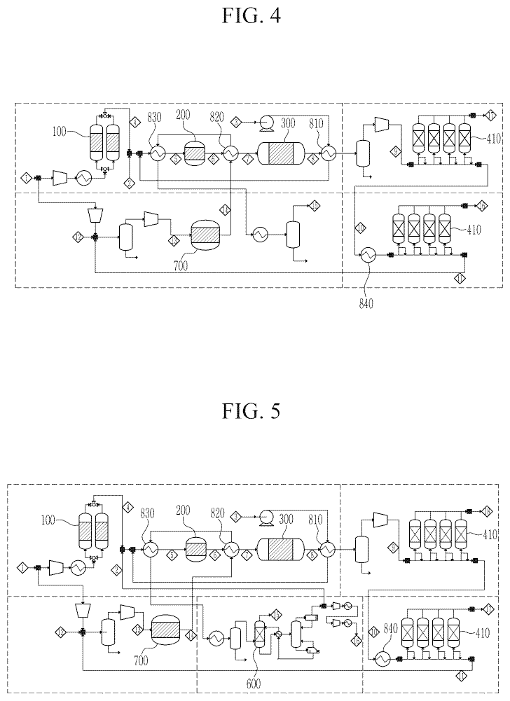

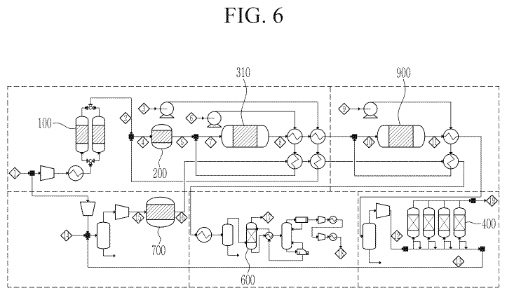

To confirm the effectiveness of the hydrogen production system according to this aspect, process simulation is performed using the Aspen Plus program. FIG. 4 is a diagram showing the device configuration of the hydrogen production system according to Example 1.

Referring to FIG. 4, CO₂ is supplied from the outside, and therefore the CO₂ capture unit 600 is omitted. At this time, CO₂ supplied from the outside may be combustion exhaust gas from industry, landfill gas, or by-product gas from steelmaking. In the present example embodiment, the system includes a heat supply unit 700 that supplies heat to the pre-reforming unit 200 and mixed reforming unit 300.

The natural gas is heat-exchanged in the third heat exchange unit 830 at an appropriate temperature (about 30° C. to about 40° C.) and then input.

The desulfurization unit 100 includes adsorptive desulfurization equipment.

The natural gas passing through the desulfurization unit 100 is heat-exchanged in the second heat exchange unit 820 and then input into the pre-reforming unit 200. In the pre-reforming unit 200 (300° C. to 400° C.), components with two or more carbons in the natural gas are converted into CH₄, and the residual sulfur components are removed.

A stream coming at the rear of the pre-reforming unit 200 is further heat-exchanged in the first heat exchange unit 810 (600° C. or more) and then input into the mixed reforming unit 300. A mixed reforming reaction may be conducted at a temperature of about 700° C. to about 1000° C. and a pressure of about 1 bar to about 30 bar. In the mixed reforming unit 300, as the mixed reforming reaction shown in Reaction Scheme 1 proceeds, CH₄, CO₂, and water vapor are converted into H₂ and CO, and some unreacted substances may be included.

After the mixed reforming reaction, gas is passed through a first separation device 410 to separate H₂ after removing moisture, etc. and then through a second separation device 420 to separate CO. The H₂ and CO separations in the first and second separation devices 410 and 420 are performed by adopting a pressure swing adsorption method.

The off-gas of the second separation device 420 is reintroduced into the heat supply unit 700 and used as a heat source.

In the present example embodiment, conditions and material flows of each unit reactor are shown in Tables 1-1 and 1-2.

TABLE 1-1

| Material | unit | 1 | 2 | 3 | 4 | 5 | 6 | 7 | 8 | 9 | 10 |
|---|---|---|---|---|---|---|---|---|---|---|---|
| Temperature | ° C. | 30.0 | 30.0 | 30.0 | 35.0 | 338.5 | 350.0 | 578.2 | 900.0 | 35.0 | 60.0 |
| Pressure | bar | 1 | 1 | 1 | 1 | 1 | 1 | 1 | 1 | 15 | 9 |
| Mass Flows | kg/hr | 753.1 | 543.4 | 563.0 | 591.7 | 1697.7 | 1697.7 | 1697.7 | 1697.7 | 1618.7 | 1441.6 |
| Mole Flows | kmol/hr | 43 | 13 | 31 | 34 | 78 | 82 | 82 | 152 | 148 | 60 |
| H₂ | kmol/hr | 0 | 0 | 0 | 0 | 0 | 5 | 5 | 98 | 98 | 10 |
| CO | kmol/hr | 0 | 0 | 0 | 0 | 0 | 0 | 0 | 47 | 47 | 47 |
| CO₂ | kmol/hr | 0 | 12 | 0 | 0 | 12 | 14 | 14 | 2 | 2 | 2 |
| H₂O | kmol/hr | 0 | 0 | 31 | 0 | 31 | 28 | 28 | 5 | 1 | 1 |
| CH₄ | kmol/hr | 41.60 | 0 | 0 | 32.68 | 32.68 | 35 | 35 | 0 | 0 | 0 |
| C₂H₆ | kmol/hr | 0.87 | 0 | 0 | 0.68 | 0.68 | 0 | 0 | 0 | 0 | 0 |
| C₃H₈ | kmol/hr | 0.26 | 0 | 0 | 0.20 | 0.20 | 0 | 0 | 0 | 0 | 0 |
| C₄H₁₀ | kmol/hr | 0.13 | 0 | 0 | 0.10 | 0.10 | 0 | 0 | 0 | 0 | 0 |
| C₅H₁₂ | kmol/hr | 0.03 | 0 | 0 | 0.03 | 0.03 | 0 | 0 | 0 | 0 | 0 |
| C₆H₁₄ | kmol/hr | 0.04 | 0 | 0 | 0.03 | 0.03 | 0 | 0 | 0 | 0 | 0 |
| C₇H₁₆ | kmol/hr | 0.35 | 0 | 0 | 0.27 | 0.27 | 0 | 0 | 0 | 0 | 0 |
| O₂ | kmol/hr | 0 | 0 | 0 | 0 | 0 | 0 | 0 | 0 | 0 | 0 |

TABLE 1-2

| | | | | | | | 16 | 17 |
|---|---|---|---|---|---|---|---|---|
| Material | unit | 11 | 12 | 13 | 14 | 15 | (CO) | (H₂) |
| Temperature | ° C. | 60.0 | 35.0 | 35.0 | 1000.0 | 40.0 | 60.0 | 35.0 |
| Pressure | bar | 9 | 15 | 30 | 30 | 1 | 9 | 1 |
| Mass Flows | kg/hr | 258.5 | 892.4 | 1299.7 | 1299.7 | 783.0 | 1183.1 | 177.1 |
| Mole Flows | kmol/hr | 18 | 28 | 54 | 47 | 18 | 42 | 88 |
| H₂ | kmol/hr | 10 | 0 | 10 | 0 | 0 | 0 | 88 |
| CO | kmol/hr | 5 | 0 | 5 | 0 | 0 | 42 | 0 |
| CO₂ | kmol/hr | 2 | 0 | 2 | 17 | 17 | 0 | 0 |
| H₂O | kmol/hr | 1 | 0 | 0 | 30 | 1 | 0 | 0 |
| CH₄ | kmol/hr | 0 | 0 | 9 | 0 | 0 | 0 | 0 |
| C₂H₆ | kmol/hr | 0 | 0 | 0 | 0 | 0 | 0 | 0 |
| C₃H₈ | kmol/hr | 0 | 0 | 0 | 0 | 0 | 0 | 0 |
| C₄H₁₀ | kmol/hr | 0 | 0 | 0 | 0 | 0 | 0 | 0 |
| C₅H₁₂ | kmol/hr | 0 | 0 | 0 | 0 | 0 | 0 | 0 |
| C₆H₁₄ | kmol/hr | 0 | 0 | 0 | 0 | 0 | 0 | 0 |
| C₇H₁₆ | kmol/hr | 0 | 0 | 0 | 0 | 0 | 0 | 0 |
| O₂ | kmol/hr | 0 | 28 | 28 | 0 | 0 | 0 | 0 |

### Example 2

FIG. 5 is a diagram showing the device configuration of the hydrogen production system according to Example 2.

In FIG. 5, unlike FIG. 4, a CO₂ capture unit 600 is added to the system to reintroduce CO₂ from the mixed reforming unit 300.

In addition, unreacted CO₂ in the mixed reforming unit 300 is recycled and then input into the CO₂ capture unit 600. In the CO₂ capture unit 600, after removing some moisture, etc. and capturing about 90% to 96% of CO₂ an appropriate ratio of the CO₂ is recirculated and then input into the mixed reforming unit 300. The uncaptured CO₂ may be separated.

In the present example embodiment, conditions and material flows of each unit reactor are shown in Tables 2-1 and 2-2.

TABLE 2-1

| | | | 2 | | | | | | | | |
|---|---|---|---|---|---|---|---|---|---|---|---|
| Material | unit | 1 | (recycle) | 3 | 4 | 5 | 6 | 7 | 8 | 9 | 10 |
| Temperature | ° C. | 30.0 | 30.0 | 30.0 | 35.0 | 341.7 | 350.0 | 578.9 | 900.0 | 35.0 | 60.0 |
| Pressure | bar | 1 | 1 | 1 | 1 | 1 | 1 | 1 | 1 | 15 | 9 |
| Mass Flows | kg/hr | 754.7 | 534.7 | 575.3 | 591.7 | 1701.7 | 1701.7 | 1701.7 | 1701.7 | 1622.5 | 1445.0 |
| Mole Flows | kmol/hr | 43 | 12 | 32 | 34 | 78 | 83 | 83 | 152 | 148 | 60 |
| H₂ | kmol/hr | 0 | 0 | 0 | 0 | 0 | 5 | 5 | 98 | 98 | 10 |
| CO | kmol/hr | 0 | 0 | 0 | 0 | 0 | 0 | 0 | 47 | 47 | 47 |
| CO₂ | kmol/hr | 0 | 12 | 0 | 0 | 12 | 14 | 14 | 2 | 2 | 2 |
| H₂O | kmol/hr | 0 | 0 | 32 | 0 | 32 | 28 | 28 | 5 | 1 | 1 |
| CH₄ | kmol/hr | 41.69 | 0 | 0 | 32.68 | 32.68 | 35 | 35 | 0 | 0 | 0 |
| C₂H₆ | kmol/hr | 0.87 | 0 | 0 | 0.68 | 0.68 | 0 | 0 | 0 | 0 | 0 |
| C₃H₈ | kmol/hr | 0.26 | 0 | 0 | 0.20 | 0.20 | 0 | 0 | 0 | 0 | 0 |
| C₄H₁₀ | kmol/hr | 0.13 | 0 | 0 | 0.10 | 0.10 | 0 | 0 | 0 | 0 | 0 |
| C₅H₁₂ | kmol/hr | 0.03 | 0 | 0 | 0.03 | 0.03 | 0 | 0 | 0 | 0 | 0 |
| C₆H₁₄ | kmol/hr | 0.04 | 0 | 0 | 0.03 | 0.03 | 0 | 0 | 0 | 0 | 0 |
| C₇H₁₆ | kmol/hr | 0.35 | 0 | 0 | 0.27 | 0.27 | 0 | 0 | 0 | 0 | 0 |
| O₂ | kmol/hr | 0 | 0 | 0 | 0 | 0 | 0 | 0 | 0 | 0 | 0 |

TABLE 2-2

| | | | | | | | 16 | 17 | 18 |
|---|---|---|---|---|---|---|---|---|---|
| Material | unit | 11 | 12 | 13 | 14 | 15 | (CO₂) | (CO) | (H₂) |
| Temperature | ° C. | 60.0 | 35.0 | 35.0 | 1000.0 | 67.6 | 30.0 | 60.0 | 35.0 |
| Pressure | bar | 9 | 15 | 30 | 30 | 1 | 150 | 9 | 1 |
| Mass Flows | kg/hr | 259.1 | 899.6 | 1309.2 | 1309.2 | 51.4 | 200.3 | 1185.9 | 177.5 |
| Mole Flows | kmol/hr | 18 | 28 | 54 | 48 | 2 | 5 | 42 | 88 |
| H₂ | kmol/hr | 10 | 0 | 10 | 0 | 0 | 0 | 0 | 88 |
| CO | kmol/hr | 5 | 0 | 5 | 0 | 0 | 0 | 42 | 0 |
| CO₂ | kmol/hr | 2 | 0 | 2 | 17 | 0.7 | 5 | 0 | 0 |
| H₂O | kmol/hr | 1 | 0 | 0 | 30 | 0.7 | 0 | 0 | 0 |
| CH₄ | kmol/hr | 0 | 0 | 9 | 0 | 0 | 0 | 0 | 0 |
| C₂H₆ | kmol/hr | 0 | 0 | 0 | 0 | 0 | 0 | 0 | 0 |
| C₃H₈ | kmol/hr | 0 | 0 | 0 | 0 | 0 | 0 | 0 | 0 |
| C₄H₁₀ | kmol/hr | 0 | 0 | 0 | 0 | 0 | 0 | 0 | 0 |
| C₅H₁₂ | kmol/hr | 0 | 0 | 0 | 0 | 0 | 0 | 0 | 0 |
| C₆H₁₄ | kmol/hr | 0 | 0 | 0 | 0 | 0 | 0 | 0 | 0 |
| C₇H₁₆ | kmol/hr | 0 | 0 | 0 | 0 | 0 | 0 | 0 | 0 |
| O₂ | kmol/hr | 0 | 28 | 28 | 0 | 0 | 0 | 0 | 0 |

### Comparative Example 1

In FIG. 5, H₂ is produced through a steam reforming reaction instead of a mixed reforming reaction as a comparative example, unlike the examples.

A CO₂ discharged amount is reduced by capturing CO₂ discharged from the process.

The same process as in the example is performed, until natural gas is desulfurized and pre-reformed. The gas at the rear end, i.e., downstream end of the pre-reforming unit 200 is heat-exchanged with the gas after the reaction to perform a steam reforming reaction. Water vapor is supplied through heat exchange with H₂O. The reaction proceeds as in Reaction Scheme 2.

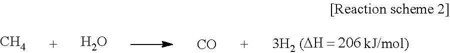

The steam reforming reaction is an endothermic reaction and may be performed at a temperature in a range of about 600° C. to about 900° C. The heat supply required for the reaction is supplied using the heat supply unit 700. After the steam reforming reaction, the gas is input into a water gas shift unit 900 for additional H₂ production. A water-gas shift reaction is an exothermic reaction and proceeds according to Reaction Scheme 3.

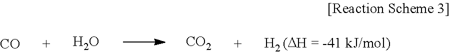

In the water-gas shift reaction, since H₂ is not only additionally produced, but CO₂ is also simultaneously produced in the same mole amount, a step of capturing the CO₂ is required to reduce CO₂ discharge of the process. About 90% to 96% of the discharged CO₂, after removing moisture, etc. therefrom in the capture unit 600, may be captured and compressed and then moved to where needed.

The rear or downstream end of the water-gas shift reaction may include H₂, unreacted CH₄, and some CO₂, which are separated and purified into pure H₂ in a pressure adsorption swing method, after removing moisture, etc. in the separation unit 400.

In the present comparative examples, conditions and material flows of each unit reactor are shown in Tables 3-1 and 3-2.

TABLE 3-1

| Material | unit | 1 | 2 | 3 | 4 | 5 | 6 | 7 | 8 | 9 | 10 |
|---|---|---|---|---|---|---|---|---|---|---|---|
| Temperature | ° C. | 35 | 35 | 30 | 186 | 350 | 30 | 521 | 850 | 40 | 230 |
| Pressure | bar | 1.0 | 1.0 | 1.0 | 1.0 | 1.0 | 1.0 | 1.0 | 1.0 | 1.0 | 1.0 |
| Mass Flows | kg/hr | 816 | 592 | 672 | 1,264 | 1,264 | 1,310 | 2,574 | 2,574 | 1,976 | 4,550 |
| Mole Flows | kmol/hr | 47 | 34 | 37 | 71 | 75 | 73 | 148 | 219 | 110 | 328 |
| H₂ | kmol/hr | 0 | 0 | 0 | 0 | 4 | 0 | 4 | 109 | 0 | 109 |
| CO | kmol/hr | 0 | 0 | 0 | 0 | 0 | 0 | 0 | 37 | 0 | 37 |
| CO₂ | kmol/hr | 0 | 0 | 0 | 0 | 2 | 0 | 2 | 0 | 0 | 0 |
| H₂O | kmol/hr | 0 | 0 | 37 | 37 | 34 | 73 | 106 | 73 | 110 | 182 |
| CH₄ | kmol/hr | 45.06 | 32.68 | 0 | 32.68 | 35 | 0 | 35 | 0 | 0 | 0 |
| C₂H₆ | kmol/hr | 0.94 | 0.68 | 0 | 0.68 | 0 | 0 | 0 | 0 | 0 | 0 |
| C₃H₈ | kmol/hr | 0.28 | 0.20 | 0 | 0.20 | 0 | 0 | 0 | 0 | 0 | 0 |
| C₄H₁₀ | kmol/hr | 0.14 | 0.10 | 0 | 0.10 | 0 | 0 | 0 | 0 | 0 | 0 |
| C₅H₁₂ | kmol/hr | 0.03 | 0.03 | 0 | 0.03 | 0 | 0 | 0 | 0 | 0 | 0 |
| C₆H₁₄ | kmol/hr | 0.05 | 0.03 | 0 | 0.03 | 0 | 0 | 0 | 0 | 0 | 0 |
| C₇H₁₆ | kmol/hr | 0.38 | 0.27 | 0 | 0.27 | 0 | 0 | 0 | 0 | 0 | 0 |
| O₂ | kmol/hr | 0.00 | 0.00 | 0 | 0.00 | 0 | 0 | 0 | 0 | 0 | 0 |

TABLE 3-2

| | | | | | | | | | 18 | 19 |
|---|---|---|---|---|---|---|---|---|---|---|
| Material | unit | 11 | 12 | 13 | 14 | 15 | 16 | 17 | (CO₂) | (H₂) |
| Temperature | ° C. | 355 | 35 | 35 | 35 | 35 | 1,000 | 40 | 40 | 35 |
| Pressure | bar | 1.0 | 15.0 | 15.0 | 15.0 | 30.0 | 30.0 | 1.0 | 150 | 1.0 |
| Mass Flows | kg/hr | 4,550 | 1,920 | 1,659 | 1,169 | 3,037 | 3,037 | 687 | 2,350 | 261 |
| Mole Flows | kmol/hr | 328 | 182 | 53 | 37 | 101 | 94 | 4 | 53 | 130 |
| H₂ | kmol/hr | 144 | 144 | 14 | 0 | 14 | 0 | 0 | 0 | 130 |
| CO | kmol/hr | 2 | 2 | 2 | 0 | 2 | 0 | 0 | 0 | 0 |
| CO₂ | kmol/hr | 35 | 35 | 35 | 0 | 35 | 51 | 1 | 49 | 0 |
| H₂O | kmol/hr | 147 | 1 | 1 | 0 | 0 | 42 | 2 | 3 | 0 |
| CH₄ | kmol/hr | 0 | 0 | 0 | 0 | 12 | 0 | 0 | 0 | 0 |
| C₂H₆ | kmol/hr | 0 | 0 | 0 | 0 | 0 | 0 | 0 | 0 | 0 |
| C₃H₈ | kmol/hr | 0 | 0 | 0 | 0 | 0 | 0 | 0 | 0 | 0 |
| C₄H₁₀ | kmol/hr | 0 | 0 | 0 | 0 | 0 | 0 | 0 | 0 | 0 |
| C₅H₁₂ | kmol/hr | 0 | 0 | 0 | 0 | 0 | 0 | 0 | 0 | 0 |
| C₆H₁₄ | kmol/hr | 0 | 0 | 0 | 0 | 0 | 0 | 0 | 0 | 0 |
| C₇H₁₆ | kmol/hr | 0 | 0 | 0 | 0 | 0 | 0 | 0 | 0 | 0 |
| O₂ | kmol/hr | 0 | 0 | 0 | 37 | 37 | 1 | 1 | 1 | 0 |

### Experimental Example 1

Examples 1 and 2 and Comparative Example 1 were compared with respect to a CO₂ discharge amount based on the same H₂ production amount.

Table 4 shows the results obtained by adding up CO₂ according to utility use through the entire process, CO₂ discharged after the reaction, and captured CO₂.

In Table 4, Example 1 use external CO₂ for the reaction, which is calculated as reduced CO₂ amount.

In addition, both unreacted CO₂ and CO₂ produced by the heat source supply were calculated to be all discharged without the CO₂ capture unit 600.

In Example 2, unreacted CO₂ was captured and recirculated and then reinput into the mixed reforming reaction. However, additional CO₂ was discharged due to energy consumed in the CO₂ capture unit 600 in addition to CO₂ produced by the heat source supply.

Similarly, in Comparative Example 1, additional CO₂ was discharged due to the energy consumed in the CO₂ capture unit 600. In Comparative Example 1, a large amount of CO₂ was discharged in the water-gas shift reaction for producing additional H₂ in addition to the CO₂ produced by the heat source supply.

Table 4 shows a total CO₂ discharge amount throughout the entire process including the aforementioned items.

TABLE 4

| | | Example 1 | Example 2 | Comparative |
|---|---|---|---|---|
| | | (using | (CO₂ | Example 1 |
| | unit | external CO₂) | recirculation) | (SMR + CC) |
| 1) Feed CO₂ reduction amount | kgCO₂eq/y | −4,181,962 | 0 | 0 |
| 2) Utility discharge CO₂ | kgCO₂eq/y | 2,659,381 | 5,032,497 | 11,927,951 |
| equipment electric power | kgCO₂eq/y | 2,555,544 | 2,620,561 | 4,356,534 |
| high temperature high | | 0 | 0 | 376,955 |
| pressure water vapor | | | | |
| low temperature low | | 103,837 | 2,411,936 | 7,194,462 |
| pressure water vapor | | | | |
| 3) Discharge CO₂ after reaction | kgCO₂eq/y | 6,025,317 | 292,895 | 723,351 |
| 4) Captured CO₂ | kgCO₂eq/y | 0 | 1,768,970 | 17,756,985 |
| 5) H₂ produced after reaction | kgH₂/y | 1,416,699 | 1,416,698 | 2,088,875 |
| Total CO₂ discharge amount | kgCO₂eq/kgH₂ | 3.18 | 3.76 | 6.06 |
| Feed CO₂ reduction [=1/5] | kgCO₂eq/kgH₂ | −2.95 | 0.00 | 0.00 |
| Utility discharge [=2/5] | | 1.88 | 3.55 | 5.71 |
| Discharge after reaction [=3/5] | | 4.25 | 0.21 | 0.35 |

Referring to Table 4, as a result of calculating total CO₂ discharge amounts of Examples 1 and 2 and Comparative Example 1, compared with that of Comparative Example 1 using steam reforming, in Examples 1 and 2 producing H₂, the CO₂ discharge amounts were reduced. In addition, Example 1 using external CO₂, which was calculated as a CO₂ reduction amount, exhibited a more reduced CO₂ discharge amount than Example 2 additionally using a capture process for recirculating CO₂.

### Experimental Example 2

Examples 1 and 2 and Comparative Example 1 were compared with respect to an energy efficiency factor (EEF) of input energy to produced energy. This means how much carbon and energy are stored in products during the entire process.

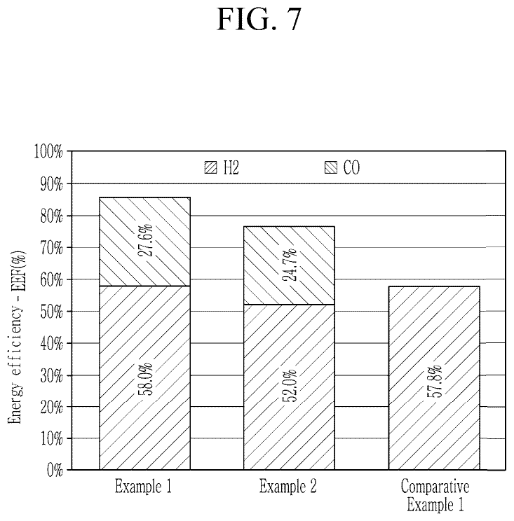

The energy efficiency (EEF) was calculated according to Equation 1. In Equation 1, the energy of inputs and products is calculated as reaction enthalpy. Types of input energy into the process for producing H₂ include natural gas, utility power (electricity, heat, cooling, etc.), etc., and types of the product energy include H₂ and CO. The energy efficiency results are shown in FIG. 7.

Equation 1

$$Energy effciency ( \% ) = \frac{product energy}{input energy + utility power} \times 100$$

Referring to FIG. 7, Examples 1 and 2, producing H₂ and CO together, exhibited energy efficiency of 75% or more. Comparative Example 1, which consumed a large amount of heat to produce water vapor, exhibited deteriorated energy efficiency.

While the technical concept of the present disclosure has been described in connection with what is presently considered to be practical example embodiments, it is to be understood that the present disclosure is not limited to the described embodiments. On the contrary, it is intended to cover various modifications and equivalent arrangements included within the spirit and scope of the appended claims.

### DESCRIPTION OF SYMBOLS

100: desulfurization unit
200: pre-reforming unit
300: mixed reforming unit
400: separation unit
410: first separation device
420: second separation device
500: water supply unit
600: carbon dioxide capture unit
700: heat supply unit
810: first heat exchange unit
820: second heat exchange unit
830: third heat exchange unit
840: fourth heat exchange unit
900: water gas shift unit

What is claimed is:

1. A hydrogen production system, comprising:
a desulfurization unit configured to remove a sulfur component from hydrocarbon gas;
a pre-reforming unit configured to convert hydrocarbons having two or more carbon atoms into methane (CH₄) by reacting the hydrocarbon gas with water (H₂O) vapor;
a mixed reforming unit configured to produce hydrogen (H₂) and carbon monoxide (CO) by performing a mixed reforming reaction between the reaction product of the pre-reforming unit and carbon dioxide (CO₂);
a separation unit for separating H₂ and CO from the reaction product of the mixed reforming unit; and
a first heat exchange unit configured to generate water vapor supplied to the pre-reforming unit using the heat of the reaction product of the mixed reforming unit.

2. The hydrogen production system of claim 1, wherein the hydrocarbon gas includes C₁ to C₂₀ alkane, C₁ to C₂₀ alkene, C₂ to C₂₀ alkyne, CO₂, ammonia, formic acid (HCO₂H), methanol (CH₃OH), or a combination thereof.

3. The hydrogen production system of claim 1, wherein
the pre-reforming unit reacts hydrocarbon gas with water vapor to convert hydrocarbons having two or more carbon atoms into CH₄ and at the same time removes remaining sulfur component.

4. The hydrogen production system of claim 1, wherein the pre-reforming unit is performed at a pressure in a range of between about 1 bar and about 30 bar and a temperature in a range of between about 300° C. and about 650° C.

5. The hydrogen production system of claim 1, wherein the mixed reforming unit is performed at a pressure in a range of between about 1 bar and about 30 bar and a temperature in a range of between about 700° C. and about 1000° C.

6. The hydrogen production system of claim 1, wherein the hydrogen production system further includes a heat supply unit that combusts hydrocarbon gas to generate a combustion product.

7. The hydrogen production system of claim 6, wherein the hydrogen production system further includes a second heat exchange unit that supplies heat to the reaction product of the pre-reforming unit and CO₂ using heat from the combustion product.

8. The hydrogen production system of claim 7, wherein the unreacted gas separated in the separation unit is supplied back to the mixed reforming unit through the second heat exchange unit.

9. The hydrogen production system of claim 6, wherein the hydrogen production system further includes a third heat exchange unit that supplies heat to the hydrocarbon gas and water vapor using heat from combustion product.

10. The hydrogen production system of claim 9, wherein the combustion product supplied to the third heat exchange unit is supplied to the third heat exchange unit through the second heat exchange unit.

11. The hydrogen production system of claim 9, wherein the CO₂ is supplied from an upstream end of the pre-reforming unit, is passed through the third heat exchange unit, the pre-reforming unit, and the second heat exchange unit, and then is supplied to the mixed reforming unit.

12. The hydrogen production system of claim 9, wherein the hydrogen production system further comprises:
a carbon dioxide capture unit that captures CO₂ from combustion product that has passed through the third heat exchange unit, and that supplies the captured CO₂ to an upstream end of the pre-reforming unit.

13. The hydrogen production system of claim 12, wherein the carbon dioxide capture unit captures the CO₂ from the unreacted gas separated in the separation unit.

14. The hydrogen production system of claim 12, wherein in the carbon dioxide capture unit, the CO₂ is captured using an absorption method, an adsorption method, a separation membrane method, or a cryogenic separation method.

15. The hydrogen production system of claim 1, wherein the separating in the separation unit is performed using pressure swing adsorption, membrane separation, or cryogenic separation.

16. The hydrogen production system of claim 15, wherein the separation unit comprises:
a first separation device that separates carbon monoxide using a cryogenic separation method; and
a second separation device that is disposed at a downstream end of the first separation device and separates hydrogen using a pressure swing adsorption method.
